(19) United States
(12) Patent Application Publication
(10) Pub. No.: US 2026/0291090 A1
(43) Pub. Date: Sep. 24, 2026

(54) TERMINAL BLOCK

(71) Applicant: Yazaki Corporation, Tokyo (JP)

(72) Inventors: Masatoshi YAMADA, Shizuoka (JP); Masato AKINO, Shizuoka (JP); Yasuhiro TANAKA, Shizuoka (JP); Yasuhiro OTSUTA, Shizuoka (JP); Sota ARAI, Shizuoka (JP); Yusuke TSUTAGAWA, Shizuoka (JP)

(73) Assignee: Yazaki Corporation, Tokyo (JP)

(21) Appl. No.: 19/541,568

(22) Filed: Feb. 17, 2026

(30) Foreign Application Priority Data
Mar. 18, 2025 (JP) 2025-043677

(51) Int. Cl. H01R 9/24; H01R 13/115; H01R 13/50; H01R 13/514; H01R 13/52

(52) U.S. Cl. CPC H01R 9/2416; H01R 9/24; H01R 13/115; H01R 13/50; H01R 13/514; H01R 13/5202; H01R 13/521

(57) ABSTRACT

A terminal block includes a housing that includes a busbar holding portion, an attachment surface and an annular shaped recessed groove provided in an annular shape on the attachment surface on an outer side of the busbar holding portion, and a seal member that has an annular shape and is provided in the annular shaped recessed groove. The seal member includes: an inner side projection; and an outer side projection. A recessed step portion formed in a recessed shape including a step portion is provided in one of: an inner side edge portion; and an outer side edge portion. A protrusion height of one of the inner side projection and the outer side projection, corresponding to the side on which the recessed step portion is provided, is formed to be smaller than the protrusion height of the other of the inner side projection and the outer side projection.

### CROSS-REFERENCE TO RELATED APPLICATIONS

The present application claims priority to and incorporates by reference the entire contents of Japanese Patent Application No. 2025-043677 filed in Japan on Mar. 18, 2025.

### BACKGROUND OF THE INVENTION

### 1. Field of the Invention

The present invention relates to a terminal block.

### 2. Description of the Related Art

As a technique related to a conventional terminal block, for example, Japanese Patent Application Laid-open No. JP 2012 – 174 505 A discloses a terminal block including: a busbar holding portion that holds a busbar; a flange that supports the busbar holding portion; an annular shaped groove formed on a surface of the flange facing an attachment target so as to surround the busbar holding portion; and an annular shaped seal gasket as a seal member to be attached to the annular shaped groove. The seal gasket is provided with a projection protruding toward a side wall of the annular shaped groove.

Meanwhile, in such a terminal block, for example, when the seal gasket is inserted into the annular shaped groove, the projection provided on the seal gasket comes into sliding contact with the side wall of the annular shaped groove and receives insertion resistance, making it difficult to assemble the seal gasket to the annular shaped groove in some cases. There is still room for further improvement in the configuration for assembling the seal member such as a seal gasket to the terminal block.

### SUMMARY OF THE INVENTION

The present invention has been made in view of the above circumstances, and an object of the present invention is to provide a terminal block to which a seal member can be appropriately assembled.

In order to achieve the above mentioned object, a terminal block according to one aspect of the present invention includes a housing that includes a busbar holding portion holding a busbar extending in an axial direction, an attachment surface provided to intersect the axial direction so as to abut on an attachment target, and an annular shaped recessed groove provided in an annular shape on the attachment surface on an outer side of the busbar holding portion around the axial direction; and a seal member that has an annular shape and is provided in the annular shaped recessed groove; wherein the annular shaped recessed groove includes an inner side wall surface on an inner side of the annular shape; and an outer side wall surface on the outer side of the annular shape, the seal member includes an inner side projection provided on the inner side surface in the annular shape in the seal member so as to protrude toward the inner side wall surface and an outer side projection provided on the outer side surface in the annular shape in the seal member so as to protrude toward the outer side wall surface, a recessed step portion formed in a recessed shape including a step portion is provided in one of: an inner side edge portion, which is one of the inner side edge portion where the attachment surface is connected to the inner side wall surface; and an outer side edge portion where the attachment surface is connected to the outer side wall surface, and a protrusion height of one of the inner side projection and the outer side projection, corresponding to a side on which the recessed step portion is provided, is formed to be smaller than the protrusion height of an other of the inner side projection and the outer side projection.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a state where a terminal block according to an embodiment is attached to an attachment target schematically illustrated;

FIG. 2 is an exploded perspective view illustrating the terminal block and the attachment target according to the embodiment;

FIG. 3 is a front view illustrating a seal member according to the embodiment;

FIG. 4 is a cross-sectional view corresponding to a VI-VI cross section of FIG. 1, and is a cross-sectional view illustrating an initial state after insertion of the seal member into an annular shaped recessed groove;

FIG. 5 is a cross-sectional view corresponding to a VI-VI cross section of FIG. 1, and is a cross-sectional view illustrating a state where the inner side projection of the seal member has abutted on the recessed step portion of the annular shaped recessed groove and has pushed the outer side of the seal member; and

FIG. 6 is a VI-VI cross-sectional view of FIG. 1.

### DETAILED DESCRIPTION OF THE PREFERRED EMBODIMENTS

An embodiment according to the present invention will be described below in detail with reference to the drawings. Note that the present invention is not limited by the present embodiment. Moreover, components in the following embodiment include those easily interchangeable by those skilled in the art or substantially identical.

### Embodiment

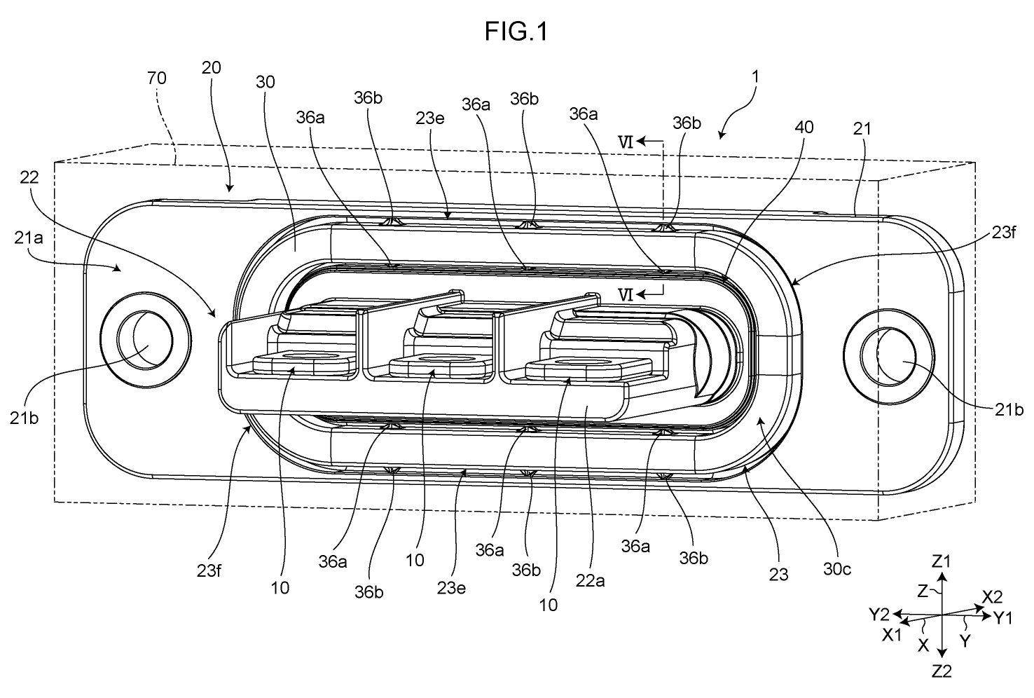

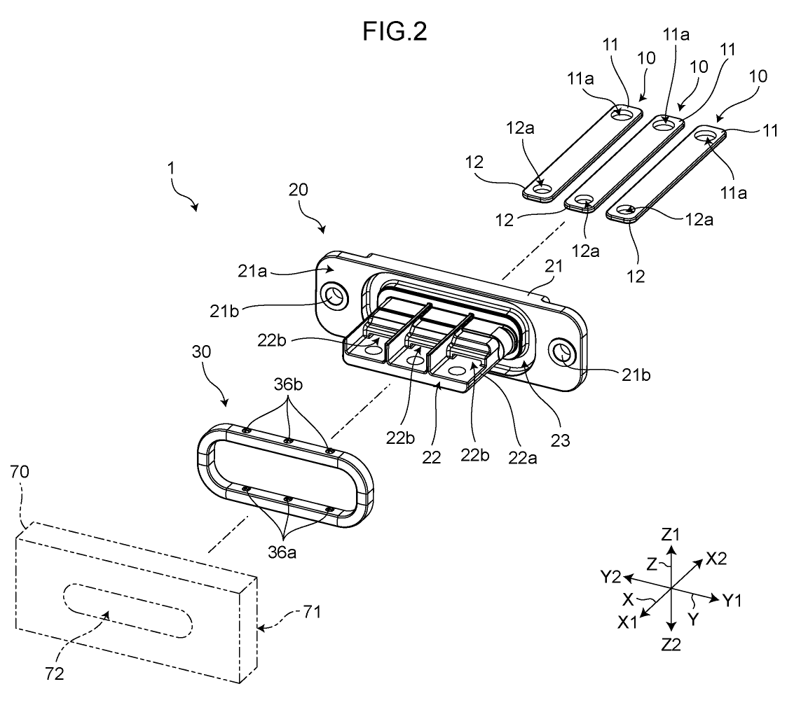

A terminal block 1 of the present embodiment illustrated in FIG. 1 is mounted on a vehicle such as an electric vehicle or a hybrid vehicle, for example, so as to be attached to an attachment target 70 indicated by a two-dot chain line and relay electrical connection between a first device and a second device (not illustrated). The terminal block 1 of the present embodiment includes a plurality of busbars 10. The plurality of busbars 10 each includes, on its one end, a first connection portion 11 (refer to FIG. 2) to which an external terminal of a first device is electrically connected. In the terminal block 1 of the present embodiment, the plurality of busbars 10 each includes, on its other end, a second connection portion 12 (refer to FIG. 2) to which an external terminal of a second device is electrically connected. The first device is one of a motor and an inverter, for example, and the second device is the other of the motor and the inverter, for example. The terminal block 1 is not limited to this example, and may be used for, for example, relaying between the first device or the second device and a wiring member, relaying between a wiring member and another wiring member, etc.

In the following description, a direction in which the busbars 10 extend is defined as an axial direction X, a direction orthogonal to the axial direction X and in which the plurality of busbars 10 are arrayed is defined as a width direction Y, and a direction orthogonal to the axial direction X and the width direction Y is defined as a height direction Z. In addition, one side in the axial direction X is defined as one side X1, and the other side is defined as the other side X2. Similarly, one side and the other side are defined as one side Y1 and the other side Y2 in the width direction Y, and one side and the other side are defined as one side Z1 and the other side Z2 in the height direction Z.

As illustrated in FIGS. 1 and 2, the terminal block 1 includes a housing 20 provided with the plurality of busbars 10. The housing 20 is provided with a seal member 30. The seal member 30 is also referred to as a seal gasket, and is formed of an elastically deformable material such as rubber or resin. The busbar 10 is a terminal fitting formed of a conductive metal material, and is electrically and mechanically connected to the external terminal described above. In the terminal block 1, three busbars 10 are arrayed to be aligned in the width direction Y.

The busbar 10 includes a first connection portion 11 and a second connection portion 12, and is formed in a long rectangular plate shape elongated in the axial direction X. The first connection portion 11 is formed on the other side X2 of the busbar 10 in the axial direction X, while the second connection portion 12 is formed on the one side X1. In the neighborhood of the end on the other side X2 in the axial direction X of the first connection portion 11, a connection hole 11a penetrating in the height direction Z is provided. Similarly, in the neighborhood of the end on the one side X1 in the axial direction X of the second connection portion 12, a connection hole 12a penetrating in the height direction Z is provided. The first device described above is connected to the connection hole 11a of the first connection portion 11, while the second device described above is connected to the connection hole 12a of the second connection portion 12.

The housing 20 is formed of a material such as an insulating synthetic resin material, and includes a housing body 21, which is a body having a substantially long rectangular plate shape with its longitudinal direction aligned with the width direction Y. A surface on one side X1 in the axial direction X of the housing body 21 is a surface directed in the axial direction X, and is an attachment surface 21a, being a substantially flat surface that abuts on an attachment target surface 71 of the attachment target 70. In the neighborhood of each end on one side Y1 and the other side Y2 in the width direction Y of the housing body 21, an attachment hole 21b is provided individually. The attachment hole 21b is a hole penetrating in the axial direction X, and a bolt (not illustrated) is inserted into the attachment hole 21b to fix the terminal block 1 to the attachment target 70 via the attachment hole 21b.

In a substantially central portion of the housing body 21 of the housing 20 in the width direction Y, a busbar holding portion 22 is provided. The busbar holding portion 22 holds the plurality of busbars 10 extending in the axial direction X so as to orthogonally intersect the attachment surface 21a. When the terminal block 1 is attached to the attachment target 70, the busbar holding portion 22 is inserted into an insertion hole 72 formed in a substantially rounded long rectangular shape elongated in the width direction Y in the attachment target 70. The busbar holding portion 22 is provided with a busbar holding protrusion 22a protruding toward one side X1 in the axial direction X. The busbar holding protrusion 22a is formed in a substantially flat plate shape with the plate surface facing the height direction Z. The busbar holding portion 22 is provided with three busbar attachment portions 22b to which the individual busbars 10 are attached. In FIG. 2, the busbar attachment portion 22b is illustrated in a flat hole shape penetrating in the axial direction X. In the present embodiment, the busbar 10 is attached to the busbar attachment portion 22b by insert molding. The busbar holding protrusion 22a is provided with partition plates corresponding to the three busbars 10. In this manner, the busbar holding portion 22 holds the plurality of busbars 10 arrayed in the width direction Y.

On the attachment surface 21a on the outer side of the busbar holding portion 22 around the axial direction X, there is provided an annular shaped recessed groove 23 in which a recessed groove is formed in an annular shape so as to surround the busbar holding portion 22. The annular shaped recessed groove 23 is formed in a long annular shape elongated in the width direction Y, that is, the direction in which the plurality of busbars 10 are arrayed. The seal member 30 is fitted into the annular shaped recessed groove 23. The seal member 30 is formed in a long annular shape elongated in the width direction Y in which the busbars 10 are arrayed.

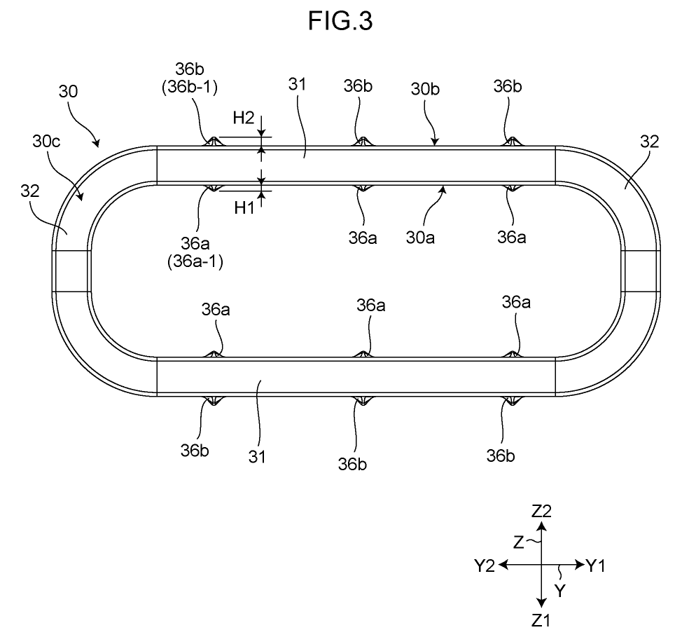

As illustrated in FIG. 3, the seal member 30 includes: an inner side surface 30a having an annular shape; and an outer side surface 30b having an annular shape. In the seal member 30, a long portion 31 which is a portion elongated substantially in a straight line shape in the width direction Y is provided on each of one side Z1 and the other side Z2 in the height direction Z. In addition, the seal member 30 is provided with two connection portions 32 including portions which are formed to be curved so as to connect the end on one side Y1 and the end on the other side Y2 in the width direction Y of the two long portions 31. The annular shaped recessed groove 23 of the housing 20 is formed in substantially the same outer shape as the seal member 30 (long annular shape elongated in the direction in which the busbars 10 are arrayed). The annular shaped recessed groove 23 is provided with a long portion 23e individually on one side Z1 and the other side Z2 in the height direction Z. In addition, in the annular shaped recessed groove 23, a connection portion 23f curved to connect the ends of the two long portions 23e is provided on each of one side Y1 and the other side Y2 in the width direction Y (refer to FIG. 1).

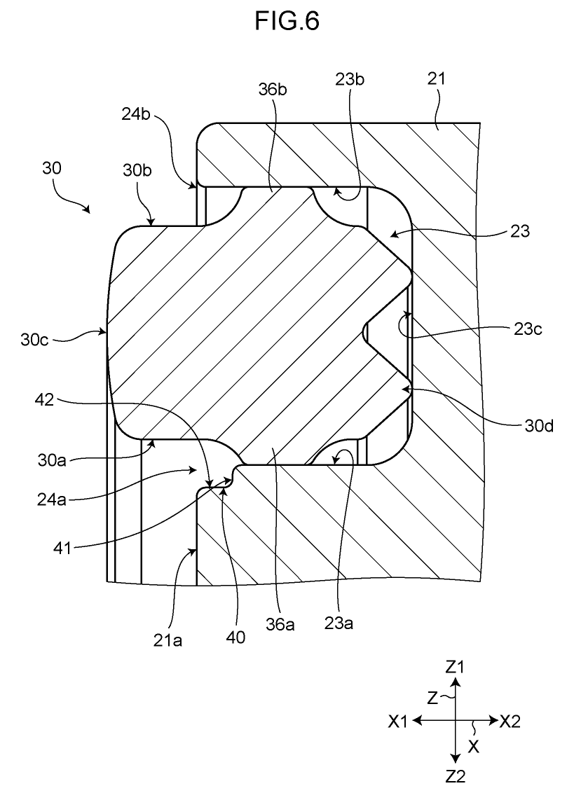

As illustrated in FIG. 3, three inner side projections 36a are provided on the inner side surface 30a of a long portion 31 on each of the one side Z1 and the other side Z2 in the height direction Z of the seal member 30. In addition, three outer side projections 36b are provided on the outer side surface 30b of the long portion 31 on each of the one side Z1 and the other side Z2 in the height direction Z of the seal member 30. Six inner side projections 36a in total and six outer side projections 36b in total are provided on the seal member 30. The inner side projection 36a protrudes toward an inner side wall surface 23a of the annular shaped recessed groove 23 (refer to FIG. 6). Similarly, the outer side projection 36b protrudes toward an outer side wall surface 23b of the annular shaped recessed groove 23 (refer to FIG. 6).

The three inner side projections 36a and the three outer side projections 36b of the long portions 31 are arranged at substantially equal intervals in the width direction Y. The inner side projection 36a and the outer side projection 36b are formed in a substantially bump shape as viewed in the axial direction X. As also illustrated in FIGS. 3 and 6, one side X1 and the other side X2 in the axial direction X of the inner side projection 36a are formed in a recessed curved surface shape and connected to the inner side surface 30a. One side Y1 and the other side Y2 in the width direction Y of the inner side projection 36a are formed in a recessed curved shape and connected to the inner side surface 30a. Similarly, one side X1 and the other side X2 in the axial direction X and one side Y1 and the other side Y2 in the width direction Y of the outer side projection 36b are formed in a recessed curved surface and connected to the outer side surface 30b.

Here, as illustrated in FIG. 3, one of the inner side projections 36a (for example, an inner side projection 36a-1 at the other side Y2 end in the width direction Y in FIG. 3) is provided to face one of the outer side projections 36b (for example, an outer side projection 36b-1 at the end of the other side Y2 in the width direction Y in FIG. 3) on the outer side surface 30b facing the inner side surface 30a on which the one inner side projection 36a is provided. In other words, the one inner side projection 36a and the one outer side projection 36b are provided as a pair to face each other in the height direction Z (that is, the positions in the width direction Y are aligned). With this configuration, after the seal member 30 is assembled, the seal member 30 is uniformly pressed in the height direction Z by the inner side projection 36a and the outer side projection 36b, making it possible to dispose the seal member 30 in the annular shaped recessed groove 23 in a well-balanced manner.

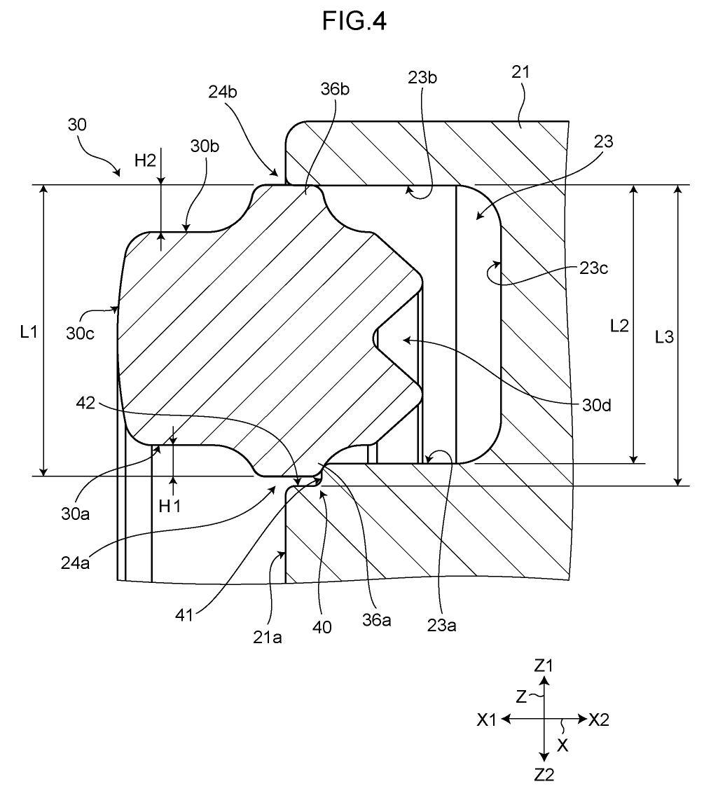

As illustrated in FIGS. 3 and 4, a protrusion height H1 of the inner side projection 36a is formed to be smaller than a protrusion height H2 of the outer side projection 36b (H1<H2). Here, as illustrated in FIG. 4, the protrusion height H1 of the inner side projection 36a is a height from the inner side surface 30a on one side X1 in the axial direction X with respect to the inner side projection 36a to the protruding edge of the inner side projection 36a. Similarly, the protrusion height H2 of the outer side projection 36b is a height from the outer side surface 30b on one side X1 in the axial direction X with respect to the outer side projection 36b to the protruding edge of the outer side projection 36b.

The cross sections of the long portion 31 and the connection portion 32 of the seal member 30 are formed in substantially rectangular shapes. A surface of the seal member 30 on one side X1 in the axial direction X is a close contact surface 30c that comes into close contact with the attachment target surface 71 of the attachment target 70. The close contact surface 30c is formed in an annular shape around the axial direction X over the two long portions 31 and the two connection portions 32. As illustrated in FIGS. 4-6, a cross section of the close contact surface 30c has a gentle bump shape. On the other side X2 in the axial direction X of the seal member 30, a lip 30d having a cross section having a shape of two bumps is provided in a continuous annular shape.

As illustrated in FIGS. 4-6, the annular shaped recessed groove 23 is formed in a recessed groove shape having a bottom surface 23c, and the inner side wall surface 23a and the outer side wall surface 23b, which rise from the bottom surface 23c. The inner side wall surface 23a is formed on the inner side of the annular shape of the annular shaped recessed groove 23, and the outer side wall surface 23b is formed on an outer side of the annular shape of the annular shaped recessed groove 23. The annular shaped recessed groove 23 opens on one side X1 in the axial direction X. An opening edge on the outer side of the annular shape in the opening edge where the annular shaped recessed groove 23 opens is defined as an outer side edge portion 24b where the attachment surface 21a is connected to the outer side wall surface 23b.

An opening edge on the inner side of the annular shape in the opening edge where the annular shaped recessed groove 23 opens is provided with a recessed step portion 40 formed in a recessed shape including a step portion 41. The recessed step portion 40 is provided in an annular shape along the annular shaped recessed groove 23. The recessed step portion 40 includes a step portion 41, which is connected to the inner side wall surface 23a via a corner rounded portion and includes a substantially flat surface facing the one side X1 in the axial direction X. The recessed step portion 40 also includes a wall surface of the recessed step portion 40, which is a step portion wall surface 42 connected to the step portion 41 and the attachment surface 21a via a corner rounded portion on each of the one side X1 and the other side X2 in the axial direction X.

As illustrated in FIG. 4, a length L1 from the protruding edge of the inner side projection 36a to the protruding edge of the outer side projection 36b is longer than a length L2 from the inner side wall surface 23a to the outer side wall surface 23b, and is smaller than a length L3 from the outer side wall surface 23b to the step portion wall surface 42 (L2<L1<L3). Here, FIG. 4 illustrates a state where the inner side projection 36a and the outer side projection 36b are not compressed.

In the present embodiment, the recessed step portion 40 is provided on an inner side edge portion 24a when the attachment surface 21a is connected to the inner side wall surface 23a. In the present embodiment, among the inner side projection 36a or the outer side projection 36b in the seal member 30, the projection corresponding to the side on which the recessed step portion 40 is provided is the inner side projection 36a. Regardless of such a configuration, for example, the recessed step portion 40 can also be provided on the outer side edge portion 24b in a case where the attachment surface 21a is connected to the outer side wall surface 23b. At this time, an annular inner side of the opening edge where the annular shaped recessed groove 23 opens is defined as an inner side edge portion 24a where the attachment surface 21a is connected to the inner side wall surface 23a. When the recessed step portion 40 is provided on the outer side of the annular shape (outer side edge portion 24b) of the annular shaped recessed groove 23, the projection corresponding to the side on which the recessed step portion 40 is provided, among the inner side projection 36a or the outer side projection 36b in the seal member 30, is the outer side projection 36b. At this time, the protrusion height H2 of the outer side projection 36b is formed to be smaller than the protrusion height H1 of the inner side projection 36a.

As illustrated in FIG. 4, the first step in assembling the seal member 30 to the terminal block 1 is directing the lip 30d of the seal member 30 to the annular shaped recessed groove 23 side of the housing 20 (housing body 21), and bringing the seal member 30 close to the annular shaped recessed groove 23 from the one side X1 in the axial direction X. At this time, the positions of the long portion 31 of the seal member 30 and the long portion 23e of the annular shaped recessed groove 23 are aligned with each other, while the positions of the connection portion 32 and the connection portion 23f are aligned with each other. When the seal member 30 is brought close to the annular shaped recessed groove 23 so as to be inserted into the annular shaped recessed groove 23, as illustrated in FIG. 4, an end of the inner side projection 36a of the seal member 30 on the other side X2 in the axial direction X abuts on the step portion 41 of the recessed step portion 40.

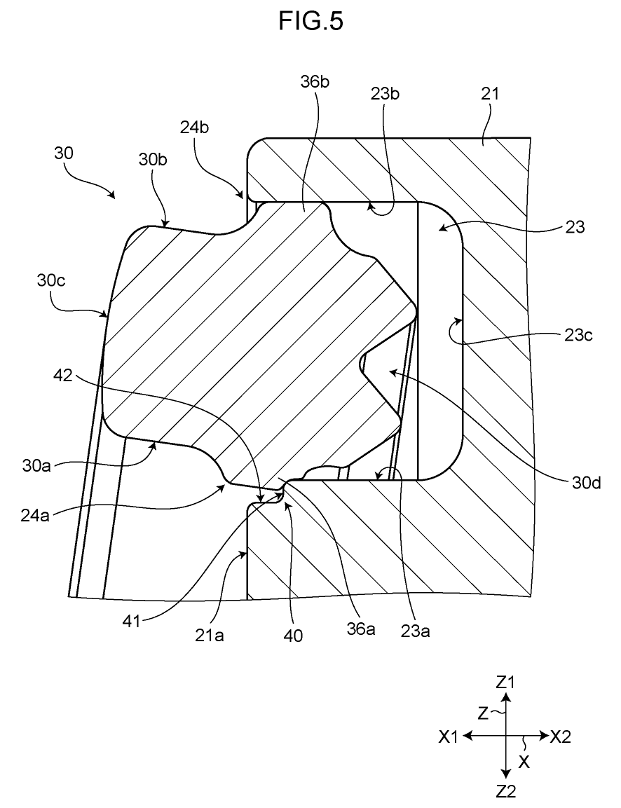

Subsequently, when the seal member 30 is further pushed by pressing the close contact surface 30c with a finger or the like, as illustrated in FIG. 5, the seal member 30 is inclined such that the outer side of the annular shape on which the outer side projection 36b not in abutment with the recessed step portion 40 is disposed enters the other side X2 (that is, the annular shaped recessed groove 23 side) in the axial direction X. Therefore, in the seal member 30, the outer side surface 30b enters the annular shaped recessed groove 23 earlier than the inner side surface 30a. That is, since the inner side projection 36a abuts on and is caught by the recessed step portion 40 in the inner side surface 30a of the seal member 30, the outer side surface 30b without being caught is first inserted into the annular shaped recessed groove 23. At this time, the outer side projection 36b is slightly pressed against the outer side wall surface 23b and elastically deformed so as to be compressed.

After the outer side surface 30b of the seal member 30 enters the annular shaped recessed groove 23 to some extent (for example, the degree to which the outer side surface 30b of the seal member 30 has no more movement to the other side X2 in the axial direction X), the worker presses the inside or the like of the close contact surface 30c with a finger. This allows the inner side surface 30a of the seal member 30 to be inserted into the annular shaped recessed groove 23. At this time, the inner side projection 36a comes into sliding contact with the inner side wall surface 23a beyond the recessed step portion 40 (step portion 41). The inner side projection 36a in sliding contact with the inner side wall surface 23a is elastically deformed and compressed. In addition, the inner side projection 36a comes into sliding contact with the inner side wall surface 23a, whereby the outer side projection 36b is further compressed.

In this manner, as illustrated in FIG. 6, in a state where the inner side projection 36a and the outer side projection 36b are compressed, the inner side projection 36a and the inner side wall surface 23a abut against each other while the outer side projection 36b and the outer side wall surface 23b abut against each other, allowing the seal member 30 to be attached to the annular shaped recessed groove 23. At this time, the lip 30d of the seal member 30 abuts on the bottom surface 23c. With elastic deformation and compression of the inner side projection 36a and the outer side projection 36b, the seal member 30 is held in a state of being attached to the annular shaped recessed groove 23, and is not easily detached from the annular shaped recessed groove 23. Therefore, even if the terminal block 1 to which the seal member 30 is assembled receives vibration due to transportation or the like, the seal member 30 would not be easily detached from the annular shaped recessed groove 23. In addition, when the terminal block 1 is attached to the attachment target 70 such that the attachment target surface 71 of the attachment target 70 abuts on the attachment surface 21a, the seal member 30 is crushed to achieve a close contact between the close contact surface 30c and the attachment target surface 71, and the lip 30d and the bottom surface 23c, allowing the busbar holding portion 22 on the inner side of the annular shape of the seal member 30 to be sealed.

The terminal block 1 described above includes: the housing 20 and the seal member 30. The housing 20 includes: the busbar holding portion 22 that holds the busbar 10 extending in the axial direction X; the attachment surface 21a provided to intersect the axial direction X so as to abut on the attachment target 70; and the annular shaped recessed groove 23 provided in an annular shape on the attachment surface 21a on the outer side of the busbar holding portion 22 around the axial direction X. The seal member 30 has an annular shape and is provided in the annular shaped recessed groove 23. The annular shaped recessed groove 23 includes: the inner side wall surface 23a on the inner side of the annular shape; and the outer side wall surface 23b on the outer side of the annular shape. The seal member 30 includes: the inner side projection 36a provided on the inner side surface 30a in the annular shape in the seal member 30 so as to protrude toward the inner side wall surface 23a; and the outer side projection 36b provided on the outer side surface 30b in the annular shape in the seal member 30 so as to protrude toward the outer side wall surface 23b. The recessed step portion 40 formed in a recessed shape including the step portion 41 is provided in one of: the inner side edge portion 24a, which is one of the inner side edge portion 24a where the attachment surface 21a is connected to the inner side wall surface 23a; and the outer side edge portion 24b where the attachment surface 21a is connected to the outer side wall surface 23b. The protrusion height H1 of the inner side projection 36a, which is one of the inner side projection 36a and the outer side projection 36b, corresponding to the side on which the recessed step portion 40 is provided, is formed to be smaller than the protrusion height H2 of the outer side projection 36b, which is the other of the inner side projection 36a and the outer side projection 36b.

With this configuration, the amount of compression of the outer side projection 36b to be compressed inserted into the annular shaped recessed groove 23 earlier may be small, and thus there is no need to use a large force for inserting the seal member 30. In addition, the inner side wall surface 23a and the inner side projection 36a come into sliding contact with each other beyond the recessed step portion 40, but since the protrusion height H1 of the inner side projection 36a is smaller than in the outer side projection 36b, the amount of compression of the inner side projection 36a is small. Accordingly, even in a state where the outer side projection 36b is in sliding contact with the outer side wall surface 23b and the inner side projection 36a is in sliding contact with the inner side wall surface 23a, it is possible to reduce the force for inserting the seal member 30 into the annular shaped recessed groove 23. Consequently, the assembling work is smoothly performed without causing the seal member 30 to be twisted by assembling the seal member 30 in the annular shaped recessed groove 23 with a strong force, making it possible to appropriately assemble the seal member 30.

For example, when the inner side projection 36a and the outer side projection 36b are formed to have a same protrusion height, one of the inner side projection 36a and the outer side projection 36b abuts on the opening edge of the annular shaped recessed groove 23, while the other first enters the annular shaped recessed groove 23. This causes inclination of the seal member 30 when being inserted into the annular shaped recessed groove 23, making it difficult to control the posture of the seal member 30. Subsequently, the inner side projection 36a or the outer side projection 36b abutting on and caught by the opening edge of the annular shaped recessed groove 23 crosses over the catch and enters the annular shaped recessed groove 23. In this case, a large force may be required. In addition, both the inner side projection 36a and the outer side projection 36b come into sliding contact with the side wall of the annular shaped recessed groove 23 and are greatly compressed, making it further necessary, in some cases, to have a large force to insert the seal member 30.

However, according to the terminal block 1 of the present embodiment, the protrusion height H1 of the inner side projection 36a corresponding to the side on which the recessed step portion 40 is provided is formed to be smaller than the protrusion height H2 of the outer side projection 36b, and thus, the inner side projection 36a abuts on the recessed step portion 40 at the initial stage of insertion of the seal member 30 into the annular shaped recessed groove 23, allowing the posture control of the seal member 30 to be reliably performed. Since the protrusion height H1 of the inner side projection 36a inserted later is small, the insertion force can be reduced. In this manner, it is possible to intentionally operate the order in which the inner side projection 36a and the outer side projection 36b are inserted, making it possible to reduce half insertion in which one protrusion is not inserted into the annular shaped recessed groove 23, leading to achievement of more reliable assembly of the seal member 30.

The length L1 from the protruding edge of the inner side projection 36a to the protruding edge of the outer side projection 36b is longer than the length L2 from the inner side wall surface 23a to the outer side wall surface 23b, and is shorter than the length L3 from the outer side wall surface 23b, which is the other of the inner side wall surface 23a and the outer side wall surface 23b, to the step portion wall surface 42, which is the wall surface of the recessed step portion 40. With this configuration, the inner side projection 36a can be reliably abutted on the step portion 41 of the recessed step portion 40.

The recessed step portion 40 is formed in an annular shape along the annular shaped recessed groove 23. In a case where the recessed step portion 40 is provided at a plurality of positions corresponding to the inner side projection 36a, it is necessary to insert the seal member 30 by aligning the inner side projection 36a with the recessed step portion 40. However, when the recessed step portion 40 is provided in an annular shape, there is no need to perform such alignment, making it possible to further facilitate the work of assembling the seal member 30.

The recessed step portion 40 is provided at the inner side edge portion 24a. With this configuration, when the worker manually assembles the seal member 30, a structure such as the busbar holding portion 22 may be provided inside the annular shape, making it difficult to apply a force to the inside of the annular shape in some cases. Therefore, with a configuration including the recessed step portion 40 provided inside the annular shape, the protrusion height H1 of the inner side edge portion 24a is also small, making it possible to reduce the insertion force inside the seal member 30 where it is difficult to work. In addition, when the recessed step portion 40 is provided on the outer side, the thickness on the outer side of the annular shaped recessed groove 23 might be further reduced. However, with the recessed step portion 40 provided on the inner side, the rigidity of the housing 20 can be easily obtained.

Note that the terminal block according to the above-described embodiment of the present invention is not limited to the above-described embodiment, and various modifications can be made within the scope described in the claims.

In the above description, the recessed step portion 40 is provided at the inner side edge portion 24a. However, the recessed step portion 40 may be provided at the outer side edge portion 24b. In this case, the protrusion height of the outer side projection 36b will be smaller than the protrusion height of the inner side projection 36a. Furthermore, the recessed step portion 40 need not be formed in an annular shape, and for example, a plurality of recessed step portions 40 may be provided in accordance with the inner side projections 36a.

The terminal block according to the present embodiment may be configured by appropriately combining the components of the above-described embodiment and modifications.

The terminal block according to the present embodiment has an effect that the seal member can be appropriately assembled.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that includes a busbar holding portion holding a busbar extending in an axial direction, an attachment surface provided to intersect the axial direction so as to abut on an attachment target, and an annular shaped recessed groove provided in an annular shape on the attachment surface on an outer side of the busbar holding portion around the axial direction; and
a seal member that has an annular shape and is provided in the annular shaped recessed groove; wherein
the annular shaped recessed groove includes an inner side wall surface on an inner side of the annular shape, and an outer side wall surface on the outer side of the annular shape,
the seal member includes an inner side projection provided on the inner side surface in the annular shape in the seal member so as to protrude toward the inner side wall surface and an outer side projection provided on the outer side surface in the annular shape in the seal member so as to protrude toward the outer side wall surface,
a recessed step portion formed in a recessed shape including a step portion is provided in one of: an inner side edge portion, which is one of the inner side edge portion where the attachment surface is connected to the inner side wall surface; and an outer side edge portion where the attachment surface is connected to the outer side wall surface, and
a protrusion height of one of the inner side projection and the outer side projection, corresponding to a side on which the recessed step portion is provided, is formed to be smaller than the protrusion height of an other of the inner side projection and the outer side projection.

2. The terminal block according to claim 1, wherein
a length from a protruding edge of the inner side projection to a protruding edge of the outer side projection is longer than a length from the inner side wall surface to the outer side wall surface, and is shorter than a length from the other of the inner side wall surface and the outer side wall surface to a wall surface of the recessed step portion.

3. The terminal block according to claim 1, wherein
the recessed step portion is formed in an annular shape along the annular shaped recessed groove.

4. The terminal block according to claim 1, wherein
the recessed step portion is provided at the inner side edge portion.

5. The terminal block according to claim 2, wherein
the recessed step portion is provided at the inner side edge portion.

6. The terminal block according to claim 3, wherein
the recessed step portion is provided at the inner side edge portion.
